(19) United States
(12) Patent Application Publication
(10) Pub. No.: US 2015/0030727 A1
(43) Pub. Date: Jan. 29, 2015

(54) FOOD PACKAGE, FOOD PACKAGING SYSTEM AND METHODS OF ASSEMBLY

(71) Applicant: HOUSE OF MEATS & BACON INC., Albert (CA)

(72) Inventor: Ralf Wollmann, Alberta (CA)

(21) Appl. No.: 14/378,520

(22) PCT Filed: Feb. 15, 2013
(86) PCT No.: PCT/CA2013/000131

§ 371 Date: Aug. 13, 2014

Related U.S. Application Data
(63) Continuation of application No. 13/397,529, filed on Feb. 15, 2012, now abandoned.

(30) Foreign Application Priority Data
Nov. 5, 2012 (CA) 2776443

(51) Int. Cl. B65B 25/06; B65B 63/04; B65B 29/08; A23L 1/31

(52) U.S. Cl. CPC B65B 25/065; A23L 1/31; B65B 63/04; B65B 29/08; A23V 2002/00
USPC 426/122; 426/106; 53/430; 53/118

(57) ABSTRACT

The present invention relates to a food package and food packaging system that minimizes the handling of food during preparation and cooking. In particular, the invention relates to a system for packaging to form a rolled food package.

### CROSS REFERENCE TO RELATED APPLICATION

This application is a national stage entry of PCT/CA2013/000131 filed Feb. 15, 2013, under the International Convention claiming priority over U.S. application Ser. No. 13/397,529 filed Feb. 15, 2012 and Canadian Application No. 2,776,443 filed May 11, 2012.

### FIELD OF THE INVENTION

The present invention relates to a food package and food packaging system that minimizes the handling of food during preparation and cooking. In particular, the invention relates to a system for packaging to form a rolled food package.

### BACKGROUND OF THE INVENTION

The food service industry is a large and diverse industry that employs thousands of people in many different businesses and business types. These include all aspects of food production and packaging, delivery to wholesale distributors, the sale of food through retail grocers and restaurants as well as the preparation of food in commercial settings including hotels and restaurants as well as home kitchens. The food service industry is also highly diverse with respect to the scope of food products within the industry including the type of food, the quality of the food products and the packaging of those food products. As is well known, within the food service industry, there are thousands of different products that portion and package almost every conceivable type of food.

In particular, in the food service and hospitality industry within hotels and restaurants, it is known that these businesses prepare food and meals in large quantities on a daily basis. Large restaurants and hotels are often producing thousands of meals per day in large commercial kitchens that employ dozens if not hundreds of chefs, cooks and helpers to handle, prepare, cook and serve these meals. In such large kitchens, the shear quantity of food that must be handled requires substantial time during all steps of meal preparation, including simply handling food in the most basic manner to enable its use in the kitchen.

By way of example of the labor requirement simply handling food, it is known that bulk food is typically delivered to a kitchen in a bulk container where it received and stored within the kitchen prior to its use. At the time of use, the food is removed from its bulk container where it may go through a series of steps including a) pre-preparation steps to prepare the food for additional processing; b) ultimately cooking the food and c) delivery of the meal to the customer. Importantly, particularly in large kitchens where a large number of meals are being prepared, the steps of removing bulk food from its containers for pre-preparation can be very time-consuming.

A particular example is the preparation and cooking of bacon within a large kitchen. Bulk bacon is typically delivered to a commercial kitchen in bulk boxes that often contain around 5 kg of bacon. Within the bulk package, smaller bags of bacon are contained where the raw bacon is sliced with the individual slices lying against one another within the smaller bag.

In a large commercial kitchen, bacon is usually cooked on parchment paper on standard size baking sheets in front-opening commercial ovens. Thus, cooking the bacon requires that the bulk bacon is removed from the bulk package and each slice be individually laid out on a sheet of parchment paper on the baking sheet. The act of separating each bacon slice and laying it flat on parchment paper is very time consuming and with a large kitchen potentially cooking up to 50 kg of bacon per day, the labor cost associated with simply moving bacon from bulk boxes to baking sheets can require thousands of man-hours per year.

For example, in a mid-size hotel kitchen with a staff of 40+ people, it would be typical for 1-2 staff to spend 1-2 hours per day simply laying out bacon on a baking sheet. This time correlates to upwards of 1000 man-hours per year which may represent a $15,000-$20,000 per year labor cost to the kitchen.

As a result, there has been a need for food products that can effectively reduce these costs to a kitchen.

In the past, in the example of bacon, various packaging solutions for bacon have been provided. For example, as exemplified in U.S. Pat. No. 3,537,497, slices of bacon may be packaged and shipped on parchment paper such that individual sheets of paper with bacon slices laid out can be simply lifted out of the bulk box package and inverted on a griddle. While this solution overcomes some of the labor costs associated with preparing bacon, there remain problems with this type of packaging, particularly around the exposure of bacon to the atmosphere and/or the requirement to touch the bacon to readjust the position of bacon slices that may inadvertently become “crumpled” as the paper is inverted over a griddle. In addition, removing a paper sheet from a bulk box requires two hands to carefully separate the different layers of parchment paper (with the layers of bacon between). Depending on temperature, bacon quality and the actions of the handler, it is common that the paper will fold or otherwise cause a shift in the position of the bacon on the paper, such that the underlying layer of bacon may be disturbed and/or the handler must then touch each piece of bacon to properly re-position it on the paper. As can be appreciated, any time spent handling the bacon is inefficient.

In a large kitchen, it is also common for bacon to be laid out on baking sheets for upwards of an hour prior to cooking as kitchen staff will spend time laying out all the bacon required for the day rather than laying out the bacon just before cooking. Thus, there is a risk of the bacon drying out and/or becoming contaminated by airborne contaminants while it remains uncovered in the kitchen.

As such, there is also a need for a packaging product that allows food products, such as bacon, to remain covered on a baking sheet until just moments before it is cooked, that reduces or eliminates the need to adjust the bacon and that otherwise does not require any touching by a handler prior to cooking.

On the consumer or retail side, bacon is typically sold in 500 g (or 1 pound) vacuum sealed packages. The bacon is typically sliced and arranged side-by-side in a slightly offset configuration; that is, each slice of bacon is laid against an adjacent slice of bacon with the long edges of the bacon offset by a few millimeters with respect to an adjacent edge. After the package is opened, the consumer manually separates each piece of bacon from the package to transfer the bacon to a cooking surface such as a frying pan or cooking sheet.

In many cases, a consumer will only cook a few slices of bacon at a time such that the opened package is returned to the refrigerator a number of times before all the bacon in the package is consumed. As is well known, conventional vacuum sealed bacon packages are not re-sealable and, as a result of juices leaking out of the opened package are often messy. Moreover, unless such packages are placed in another bag, the packages may be at least partially exposed to the air resulting in the bacon drying out whilst in the refrigerator. As can be appreciated, the use of a secondary bag to contain the opened bacon package is also wasteful.

Further still, many consumers may prefer to freeze bacon in a freezer for storage. However, as is well known, separating individual slices of bacon from a frozen slab of bacon slices is essentially impossible without either thawing the entire package or causing the disintegration of the partially or fully frozen individual slices of bacon. Accordingly, there has been a need for packaging systems that facilitate the freezing of a quantity of bacon while allowing individual slices to be readily removed.

U.S. Pat. No. 2,830,910 describes a bacon packaging product where the bacon is laid out on a continuous roll of a plastic film. Small sections of the plastic film can be separated from the roll and inverted on a frying pan to commence cooking. However, as in US '487 above, this product does not overcome the handling and exposure problems as described above.

Other examples of past packaging systems include U.S. Pat. No. 3,051,583 which describes a rolled packing system and dispenser, U.S. Pat. No. 5,520,939 which describes a rigid bacon package, U.S. Pat. No. 3,645,759 which describes a cylindrical container, U.S. Pat. No. 4,935,276 which describes an absorbent pad; U.S. Pat. No. 3,916,030 which describes a heat and serve meat package; and PCT Publication WO 2009/125175 which describes a food processing method.

### SUMMARY OF THE INVENTION

In accordance with a first aspect of the invention, there is provided a food package containing elongated slices of a food product, comprising: a flexible substrate supporting at least one row of a plurality of elongated food slices in a side by side arrangement, the flexible substrate having a length and a width; and wherein the elongated food slices are arranged substantially parallel to the length of the elongated sheet and wherein the flexible substrate supporting the elongated food slices is rolled about a roll axis substantially transverse to the length of the elongated food slices to form a substantially tubular package.

In other embodiments, the flexible substrate is selected from the group consisting of wax paper, parchment paper and aluminum foil and preferably parchment paper having a high wet strength.

In one embodiment, the elongated food slices do not overlap an adjacent elongated food slice.

In another embodiment, the food package includes a second flexible substrate placed over top of the elongated food slices prior to rolling and that preferably has a length marginally shorter than the flexible substrate.

In another embodiment, the flexible substrate includes at least one perforation located between elongated food slices when rolled allowing the separation of a portion of the tubular package from the tubular package. The package may also include a second flexible substrate placed over top of the elongated food slices prior to rolling and wherein the flexible substrates each include at least one generally co-planar perforation located between elongated food slices when rolled allowing the separation of a portion of the tubular package from the tubular package.

In one embodiment, the at least one perforation comprises a plurality of adjacent holes and tabs where the holes constitute greater than 50% of the length of the at least one perforation and preferably 80-90% of the length of the at least one perforation.

In one embodiment, the food package contains 1-3 rows of elongated food slices such as bacon.

In another aspect, the invention provides a method of preparing a food package comprising the steps of: a) placing at least one row of a plurality of elongated food slices in a side by side arrangement on a flexible substrate, the flexible substrate having a length and a width and wherein the elongated food slices are arranged substantially parallel to the length of the elongated sheet; and, b) rolling the flexible substrate supporting the elongated food slices about a roll axis substantially transverse to the length of the elongated food slices to form a substantially tubular package.

The method may also comprise the step of: after step a) placing a second flexible substrate on top of the elongated food slices prior to rolling.

In yet another aspect, the invention provides an apparatus for preparing a rolled food package comprising: a work surface having means for advancing a sheet of a flexible substrate from an upstream end to a downstream end, the flexible sheet having a first end and a second end; at least one slicing machine operatively positioned above the work surface for slicing a food product and placing non-overlapping and individual slices of the food product on the flexible substrate in a generally parallel configuration between the first end and second end; and, a rolling machine operatively positioned downstream of the at least one slicing machine having a plurality of rollers adapted for rolling the flexible sheet about the first end towards the second end about a transverse axis to form a rolled product.

The apparatus may also include a wrapping machine operatively connected to the rolling machine for packaging the rolled product and/or a covering machine operatively connected to the work surface, the covering machine adapted for applying a second flexible substrate to the top of the food product downstream of the slicing machine.

The flexible substrates may also include at least one perforation and the covering machine aligns the perforations such that after rolling each perforation is substantially co-planar with an adjacent perforation on an adjacent flexible substrate.

Other aspects and features will become apparent to those ordinarily skilled in the art upon review of the following description of specific embodiments in conjunction with the accompanying figures.

### BRIEF DESCRIPTION OF THE DRAWINGS

The invention is described with reference to the drawings in which:

FIG. 1 is a perspective view of a food transportation and storage apparatus according to a first embodiment of the invention during assembly;

FIG. 2 is a perspective view of the system of FIG. 1 in a partially rolled configuration;

FIG. 3 is a perspective view of the system of FIG. 1 in a fully rolled configuration;

FIG. 4 is a perspective view of the system of FIG. 3 being unrolled onto a baking sheet;

FIG. 5 is schematic end-view of a number of tubular packages within a bulk storage box;

FIG. 6 is a side-view of food packaging system in accordance with a second embodiment with a second flexible substrate;

FIG. 7 is a perspective view of the packaging system in a fully rolled configuration showing perforations in the flexible substrate;

FIG. 8 is a perspective view of the assembly of the packaging system in accordance with one embodiment of the invention;

FIG. 8A is a schematic top view of a package in accordance with one embodiment of the invention;

FIG. 8B is a schematic cross-section view of a package in accordance with one embodiment of the invention;

FIG. 9 is a schematic top view of a flexible substrate with perforations in accordance with one embodiment of the invention;

FIG. 10 is a schematic plan view of a manufacturing process in accordance with one embodiment of the invention;

FIG. 10A is a flow chart of a representative manufacturing process in accordance with one embodiment of the invention; and

FIG. 10B is a schematic side view of a rolling process in accordance with one embodiment of the invention.

### DETAILED DESCRIPTION

### Overview

With reference to the Figures, a food packaging assembly 10 for narrow strips of food such as bacon is described. Within this description, the assembly, packaging and handling of bacon is described although it is understood that other types of food may be packaged in a similar manner. The food packaging assembly is particularly beneficial in reducing the handling of bacon prior to cooking which can result in substantial labor savings in larger commercial settings as well as convenience to a consumer in a consumer setting.

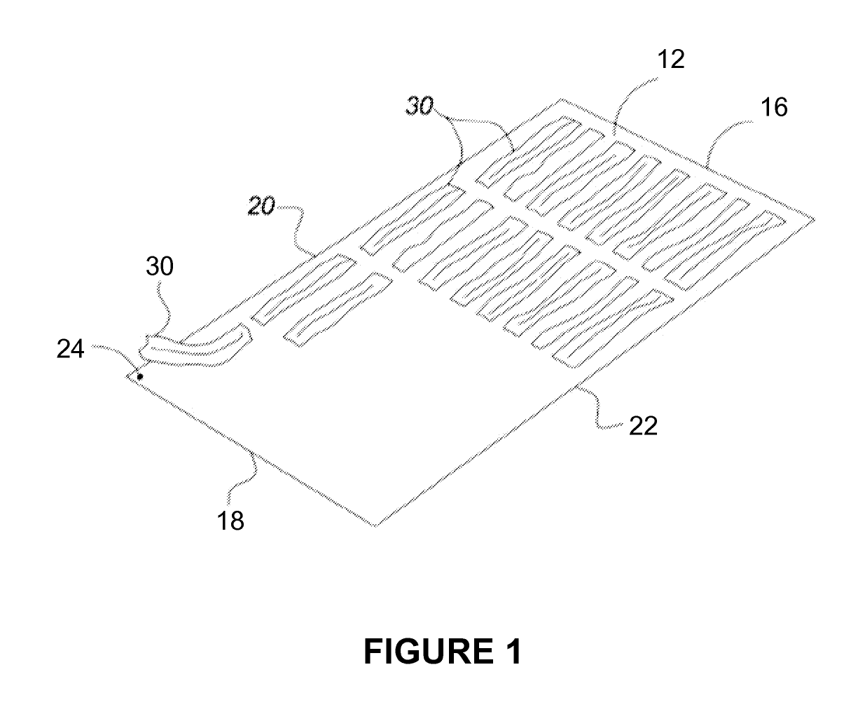

Generally, the packaging assembly 10 includes a sheet 12 of a thin and flexible material forming a substrate on which slices of bacon 30 are applied thereto as shown in FIG. 1.

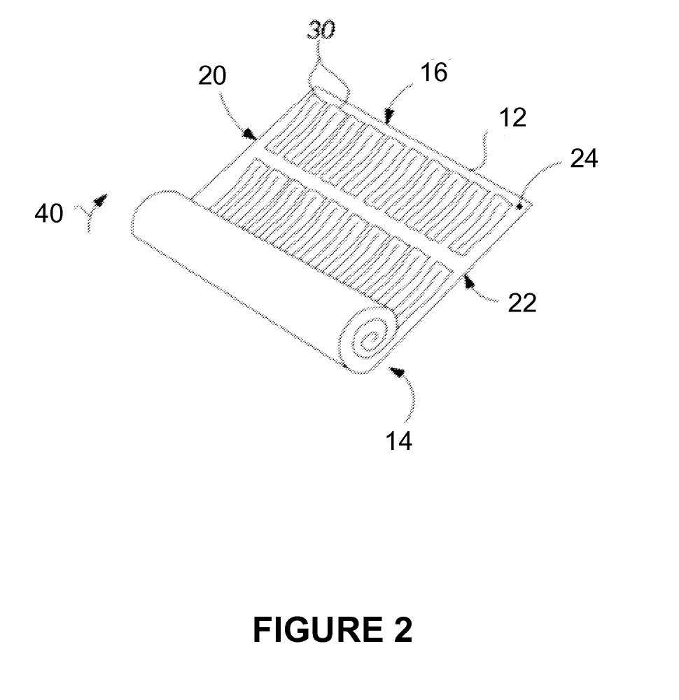

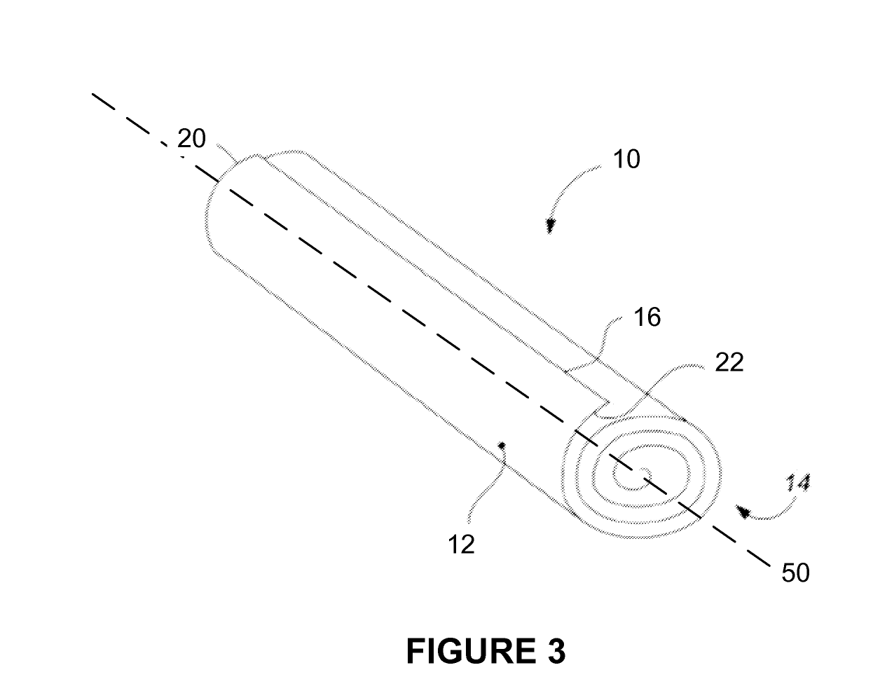

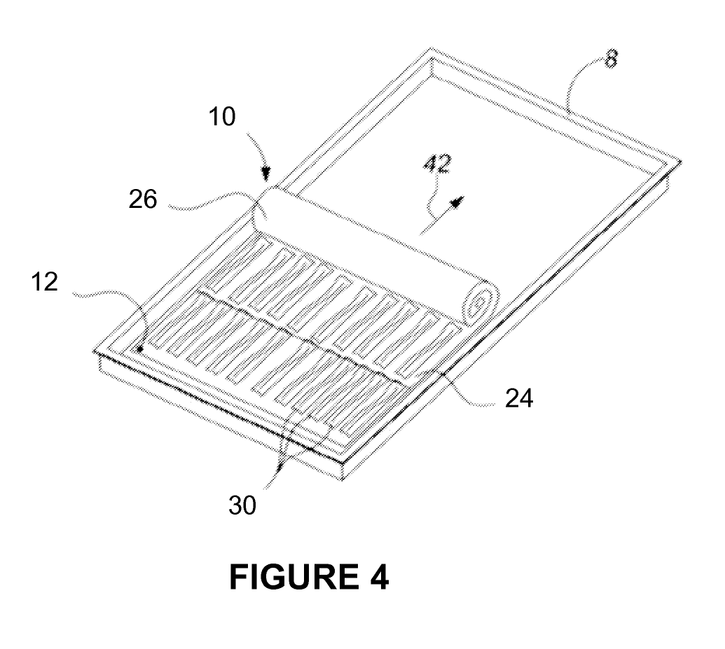

As illustrated in FIGS. 2 and 3, after the bacon has been arranged on the sheet 12 in one or more rows, the sheet 12 and bacon 30 are rolled into a tubular shape (shown as 14, FIGS. 2-3) for packaging, transportation and storage prior to cooking. As illustrated in FIG. 4, prior to cooking, the roll 14 may be unrolled onto a baking sheet 8 or the like when the bacon is to be cooked.

In a preferred embodiment, the sheet 12 is generally rectangular having first and second ends, 16 and 18 and first and second side edges, 20 and 22 respectively that are sized to fit on standard baking sheets used within front opening commercial ovens typically found within commercial kitchens. As illustrated, the sheet 12 has upper and lower surfaces, 24 and 26.

The sheet 12 may be formed of any suitable food-safe material, such as, wax paper, parchment paper and aluminum foil. Sheets formed of materials than allow the bacon to be cooked directly on the sheet are preferred. In addition, it is preferred that the sheet has sufficient strength (high wet strength) to enable a user to grasp the ends of the sheet within their hands without causing ripping or tearing of the sheet.

Furthermore, although the sheet 12 is illustrated as having a substantially rectangular shape, it will be appreciated that the sheet may also have any other suitable shape, such as, by way of non-limiting example, square, circular, oval, octagonal or irregular, that may be specifically configured to fit on baking sheets or cooking apparatus having corresponding shapes.

As shown in FIGS. 1 and 3, the food packaging assembly 10 will preferably orient the bacon in a side-by-side arrangement on the upper surface 24 with the length of the bacon generally parallel to the longer side edge of the sheet. Importantly, it is preferred that the food packaging assembly is rolled 40 such that the lengths of the bacon slices are spirally wound about a roll axis 50 of the roll 14 which is transverse to orientation of the bacon slices on the sheet. This orientation of the bacon with respect to the roll axis is important to minimize the potential of individual bacon slices adhering to the underside surface 26 of the sheet during unrolling 42. That is, by orienting the bacon in this manner, there is a lower total adhesion force between a slice of bacon and the underside of roll at the point of separation which will then maximize the ability of the bacon slice to separate from the underside of the roll. In other words, when the roll is unrolled, because the bulk of the bacon slice is contained within the roll as unrolling is commenced, the bacon slice is less likely to move from the position that it was originally laid down in as unrolling is commenced. As a result, the need for manually adjusting the position of the bacon after it has been unrolled is reduced or eliminated. In contrast, orienting the bacon substantially parallel to the roll axis is more likely to cause the bacon to adhere to an upper surface as the bacon is unrolled which may then result in it “falling” off the roll.

During assembly, it will be appreciated that the bacon 30 may be placed upon the top surface 24 of the sheet by hand or by automatic means although automation of the process is preferred as described below.

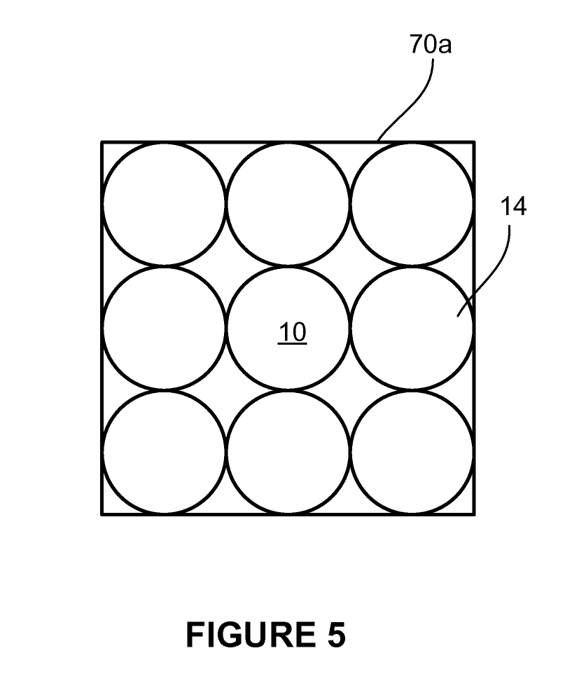

As shown in FIG. 5, after a roll has been assembled, a number of rolls may be packaged in a bulk container 70a for shipping to a customer. Individual bagging of each roll may be desired. Bulk or individual rolls may also be collectively or individually frozen.

At the time of food preparation or cooking, an individual roll is transferred to a baking sheet where it may be allowed to thaw (if frozen), immediately unrolled for cooking or alternatively remain rolled until cooking. Importantly, if the bacon is not to be cooked immediately, it can remain in a rolled configuration until immediately before cooking.

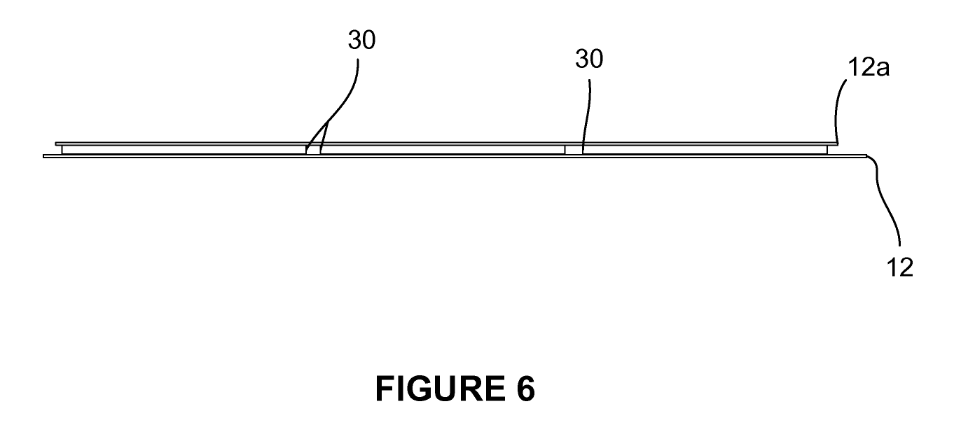

As shown in FIG. 6, a further embodiment is shown in which the roll is assembled utilizing an upper 12a and lower 12 sheet. In this embodiment, the upper sheet enhances the ability to unroll the roll without causing movement of the bacon on the sheets as within the roll, the bacon remains only in contact with the upper and lower sheets during rolling and unrolling. When the roll 14 has been unrolled, the upper sheet may be peeled and/or lifted from the upper surfaces of the bacon and discarded. It is preferred that the upper sheet 12a is marginally smaller than the lower sheet 12 to accommodate the shorter spiral distance of the upper sheet within the spiral.

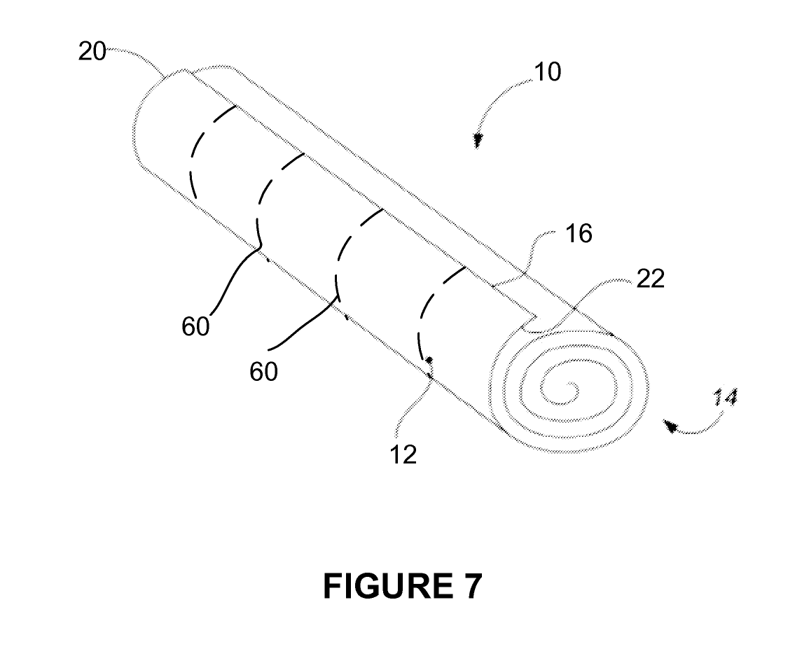

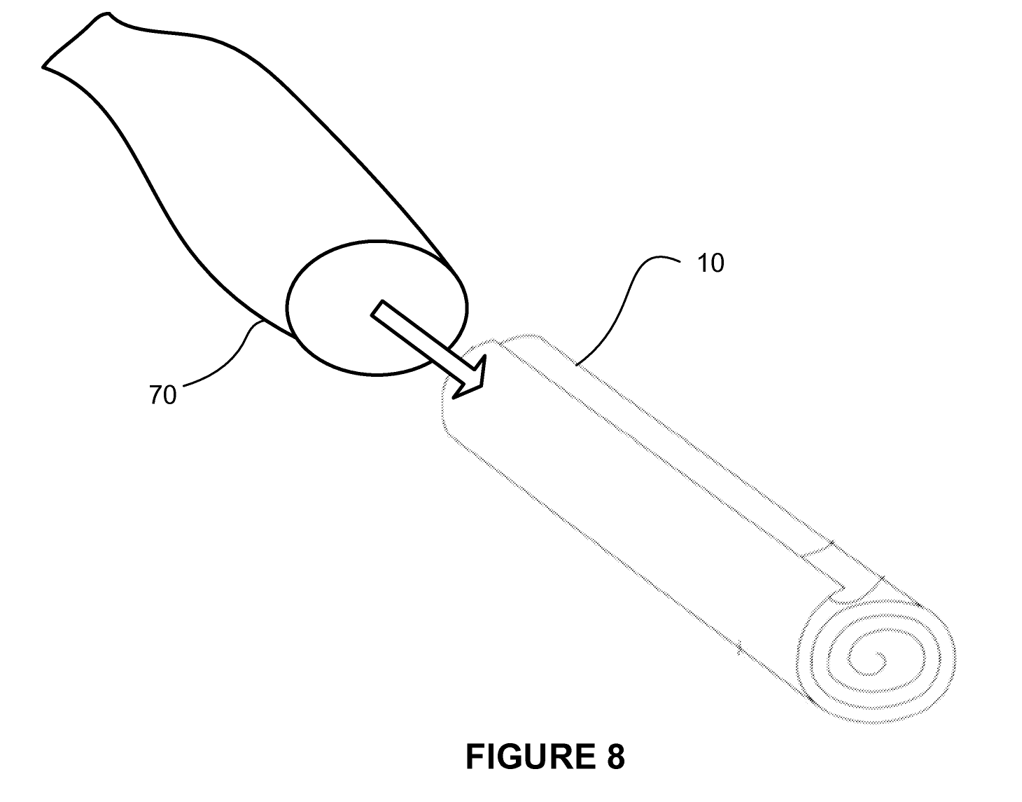

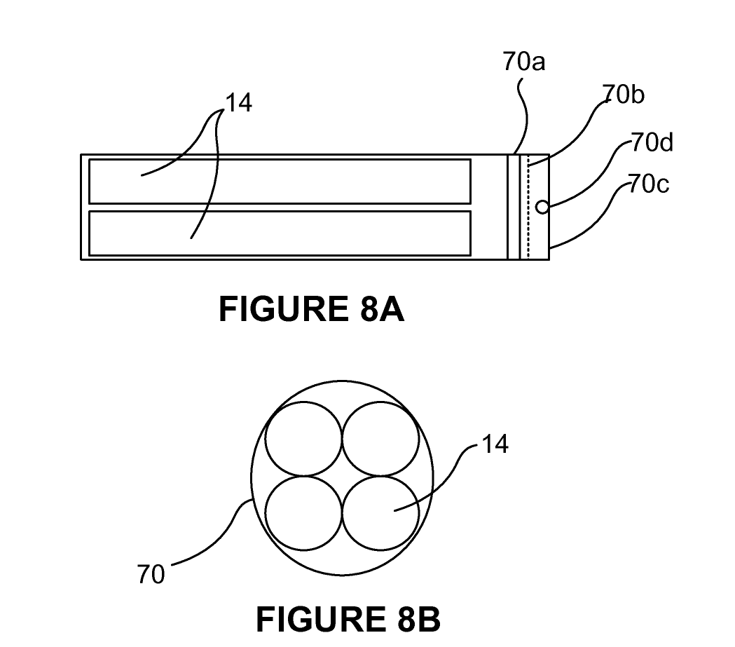

In a further embodiment, as shown in FIGS. 7 and 8, the packaging system may be adapted for consumer or retail packaging. Generally, for retail sales of bacon, that is, for home cooking, a smaller quantity of bacon is required or desired for a specific meal, where a user will often only want to cook a few slices of bacon at a time. As is known, standard packages of bacon typically contain 18-20 slices of bacon in a vacuum pack (eg. 500 g package), that once opened should be consumed within a few days. While some people may freeze an opened package, as discussed above, freezing bacon without separating the bacon into individual slices prevents separation of individual bacon slices without unthawing the entire package.

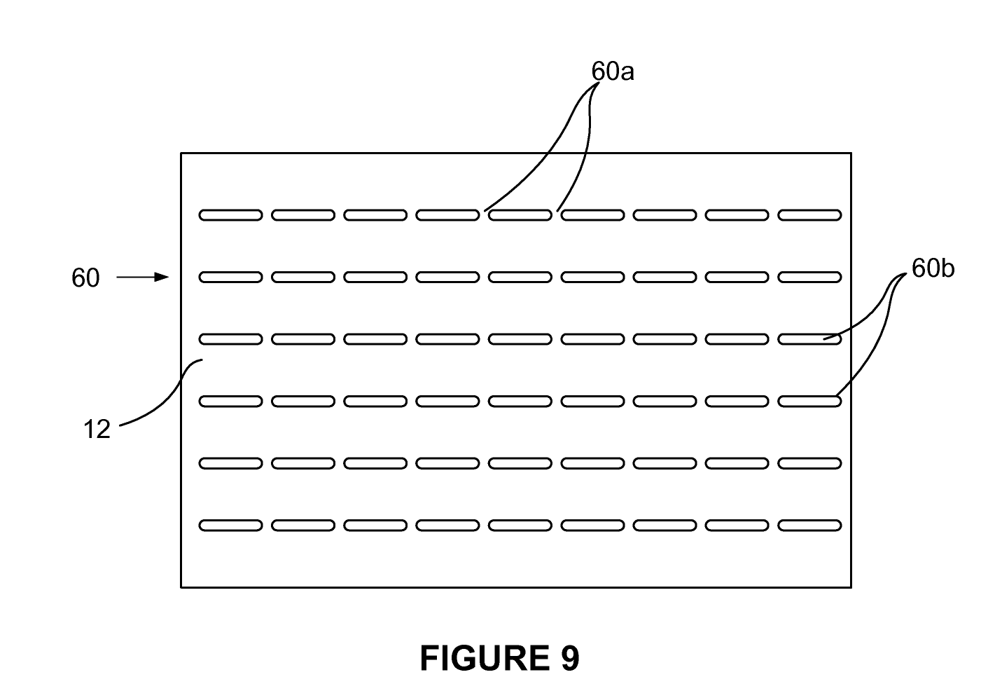

As shown in FIGS. 7 and 9, the sheet(s) used to form a roll of bacon may be provided with perforations or markings 60 aligned between the slices that allow the consumer to separate portions of the roll in order to cook a desired number of slices. Separation of individual slices can be achieved by simply tearing away one or more sections of the roll 14 or by cutting along a marking. As can be appreciated, in this case, a frozen roll of bacon could be simply removed from the freezer and a small number of slices removed from the roll without the need to unthaw the entire roll. In this embodiment, it will generally be preferred that only 1-2 rows of bacon will be on an individual sheet.

As shown in FIG. 9, the perforations or markings 60 may be perforations that include a sequence of holes 60a and tabs 60b across the sheet that provide ensure an even separation of a section of the sheet from the roll. As shown, along the line of perforations, the holes 60a correspond to approximately 90% of the length of the line of perforations with approximately 10% of the length remaining as the sheet or tabs 60b. Thus, when the sheet is rolled, and the line of perforations is substantially co-planar, the amount of sheet material that must be torn to effect separation is greatly reduced, thus making the separation significantly easier. As can be appreciated, the respective size of the holes relative to the tabs can vary based on the relative strength of the sheet to tearing, but generally will be greater than 50%. If an underlying sheet is stronger, a higher proportion of holes may be desired whereas a more easily torn sheet may have a lower proportion of holes.

As shown in FIG. 8, in one embodiment, the roll is provided with an outer covering 70 such as a bag to seal the roll for retail sales. The outer covering may be vacuum sealed. As shown in FIGS. 8A, 8B, in one embodiment, a number of individual rolls of bacon may be placed within a single outer covering 70. The outer covering 70 will preferably include a re-sealable zipper 70a together with a perforation 70b adjacent a sealed end 70c. A hole 70d may also be included to facilitate display. In this case, the sealed end of the bag may be ripped off along the perforation and product removed through the re-sealable zipper. As desired, the bag may be re-sealed using the re-sealable zipper.

### Manufacture

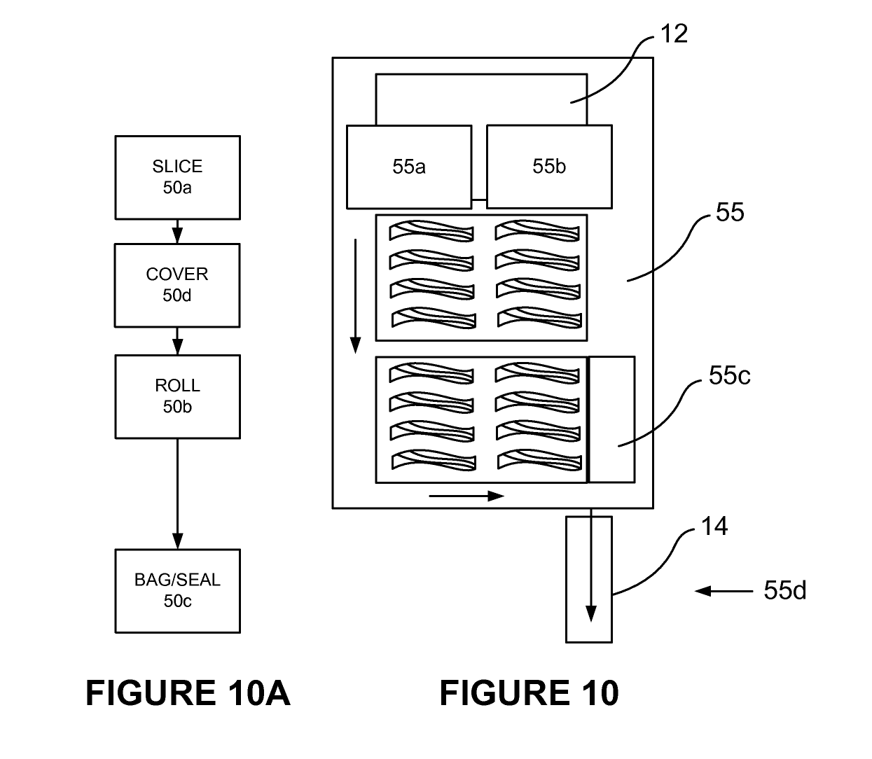

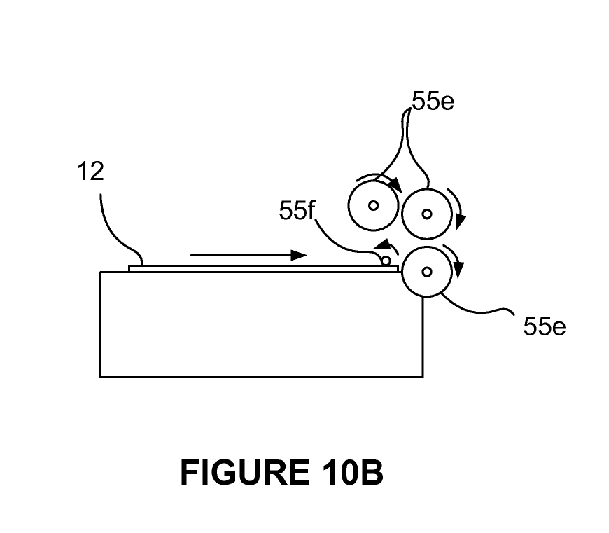

As shown in FIGS. 10, 10A, and 10B, a representative manufacturing process is described with representative machinery. The assembly of a roll 14 will generally include the steps of slicing 50a, rolling 50b and bagging/sealing 50c. In one embodiment, a series of pre-cut sheets 12 are successively advanced on a work surface 55. One or more meat slicers 55a, 55b are positioned above the work surface and progressively slice bacon onto each sheet 12 as the sheet advances beneath the slicers such that a side-by-side series of bacon slices are laid down on each sheet as shown. Once a sheet has been filled with bacon slices, the sheet may be covered with a second sheet 50d prior to rolling 50b. Perforations, if present, may also be aligned with the perforations of an underlying sheet.

A rolling station 55c will roll each sheet containing the bacon slices to form a roll 14 for subsequent packaging 50c at a bagging/sealing station 55d.

As shown, the rolling station 55c may include a series of rollers 55e, 55f that initiate rolling at one end of the sheet by gripping the underside and top surfaces of the sheet/bacon and by rotation cause a spiral to be formed. As shown, a smaller roller 55f may be utilized to provide a core template to the rolling process. Once roller, the smaller roller 55f together with transfer mechanisms (not shown) may be used to transfer a roll to the bagging sealing/station for packaging whereupon the smaller roller is withdrawn from the roll.

While specific embodiments of the invention have been described and illustrated, such embodiments should be considered illustrative of the invention only and not as limiting the invention as construed in accordance with the accompanying claims.

1. A food package containing elongated slices of a food product, comprising:
a flexible substrate supporting at least one row of a plurality of elongated food slices in a side by side arrangement, the flexible substrate having a length and a width; and
wherein the elongated food slices are arranged substantially parallel to the length of the elongated sheet and wherein the flexible substrate supporting the elongated food slices is rolled about a roll axis substantially transverse to the length of the elongated food slices to form a substantially tubular package.

2. The food package as in claim 1 wherein the flexible substrate is selected from the group consisting of wax paper, parchment paper and aluminum foil.

3. The food package as in claim 2 wherein the flexible substrate is parchment paper.

4. The food package as in claim 3 wherein the flexible substrate is parchment paper having a high wet-strength.

5. The food package as in claim 1 wherein the elongated food slices do not overlap an adjacent elongated food slice.

6. The food package as in claim 1 further comprising a second flexible substrate placed over top of the elongated food slices prior to rolling.

7. The food package as in claim 6 wherein the second flexible substrate has a length marginally shorter than the flexible substrate.

8. The food package as in claim 1 wherein the flexible substrate includes at least one perforation located between elongated food slices when rolled allowing the separation of a portion of the tubular package from the tubular package.

9. The food package as in claim 1 further comprising a second flexible substrate placed over top of the elongated food slices prior to rolling and wherein the flexible substrates each include at least one generally co-planar perforation located between elongated food slices when rolled allowing the separation of a portion of the tubular package from the tubular package.

10. The food package as in claim 8 wherein the flexible substrate is parchment paper and the at least one perforation comprises a plurality of adjacent holes and tabs where the holes constitute greater than 50% of the length of the at least one perforation.

11. The food package as in claim 10 wherein the holes are 80-90% of the length of the at least one perforation.

12. The food package as in claim 1 wherein the food package contains 1 to 3 rows of elongated food slices.

13. The food package as in claim 1 wherein the food product is slices of bacon.

14. A method of preparing a food package comprising the steps of:
a) placing at least one row of a plurality of elongated food slices in a side by side arrangement on a flexible substrate, the flexible substrate having a length and a width and wherein the elongated food slices are arranged substantially parallel to the length of the elongated sheet; and,
b) rolling the flexible substrate supporting the elongated food slices about a roll axis substantially transverse to the length of the elongated food slices to form a substantially tubular package.

15. The method as in claim 14 further comprising the step of: after step a) placing a second flexible substrate on top of the elongated food slices prior to rolling.

16. The method as in claim 15 wherein each of the flexible substrates include at least one perforation further comprising the step of aligning perforations such that after rolling each perforation on one flexible substrate is substantially coplanar with a perforation on a corresponding flexible substrate.

17. The method as in claim 14 further comprising the step of: after step b) placing and sealing the tubular structure within an exterior bag.

18. An apparatus for preparing a rolled food package comprising:
a work surface having means for advancing a sheet of a flexible substrate from an upstream end to a downstream end, the flexible sheet having a first end and a second end;
at least one slicing machine operatively positioned above the work surface for slicing a food product and placing non-overlapping and individual slices of the food product on the flexible substrate in a generally parallel configuration between the first end and second end;
a rolling machine operatively positioned downstream of the at least one slicing machine having a plurality of rollers adapted for rolling the flexible sheet about the first end towards the second end about a transverse axis to form a rolled product.

19. The apparatus as in claim 18 further comprising a wrapping machine operatively connected to the rolling machine for packaging the rolled product.

20. The apparatus as in claim 18 wherein the flexible substrate includes at least one perforation extending from the first edge to the second edge and the slicing machine places individual slices of the food product in a non-overlapping position with respect to the at least perforation.

21. The apparatus as in claim 18 further comprising a covering machine operatively connected to the work surface, the covering machine adapted for applying a second flexible substrate to the top of the food product downstream of the slicing machine.

22. The apparatus as in claim 21 wherein the flexible substrates include at least one perforation and the covering machine aligns the perforations such that after rolling each perforation is substantially co-planar with an adjacent perforation on an adjacent flexible substrate.

23. The apparatus as in claim 18 wherein the food product is bacon.

24. The method of claim 16 further comprising the step of: after step b) placing and sealing the tubular structure within an exterior bag.

25. The apparatus as in claim 20 further comprising:
a wrapping machine operatively connected to the rolling machine for packaging the rolled product;
a covering machine operatively connected to the work surface, the covering machine adapted for applying a second flexible substrate to the top of the food product downstream of the slicing machine;
wherein the flexible substrates each include at least one perforation and the covering machine aligns the perforations such that after rolling each perforation is substantially co-planar with an adjacent perforation on an adjacent flexible substrate.
